(19) United States
(12) Patent Application Publication
(10) Pub. No.: US 2025/0148197 A1
(43) Pub. Date: May 8, 2025

(54) AUTOFILL TECHNIQUES FOR SECONDARY WEB-BASED FORMS

(71) Applicant: Stripe, Inc., South San Francisco, CA (US)

(72) Inventors: David WEEDON, Edwardsville, IL (US); John WAHBA, SeaTac, WA (US)

(21) Appl. No.: 18/501,933

(22) Filed: Nov. 3, 2023

(51) Int. Cl. G06F 40/174

(52) U.S. Cl. CPC G06F 40/174

(57) ABSTRACT

Aspects of the subject technology include receiving an indication that a user has accessed a webpage comprising a form. Responsive to determining that the user is registered with a remote server, aspects also include accessing an account information of the user including an attribute, identifying a field of the form, the field including a first form information matching the attribute, generating a new selector that uniquely identifies the field in a document object model associated with the form, and transmitting, to a remote server, an indication of the new selector. Responsive to determining that the user is not registered with the remote server, aspects also include receiving a selector selected from a plurality of selectors associated with the webpage, accessing a second form information from a field of the form associated with the received selector, and autofilling a field of another form with the second form information.

### TECHNICAL FIELD

The present description generally relates to web-based forms and, more particularly, to techniques for automatic filling of web-based forms.

### BACKGROUND

Web-based forms are often used to collect information from users via an electronic device. In some instances, the information requested in such forms are commonly requested in various other web-based forms.

### BRIEF DESCRIPTION OF THE DRAWINGS

Certain features of the subject technology are set forth in the appended claims. However, for the purpose of explanation, several embodiments of the subject technology are set forth in the following figures.

FIG. 1 illustrates an example network environment in which the subject technology may be implemented, in accordance with one or more embodiments.

FIG. 2 depicts an example electronic device that may implement the subject technology, in accordance with one or more embodiments.

FIG. 3 depicts an example primary form utilized by a registered user, in accordance with one or more embodiments.

FIG. 4 depicts a process diagram illustrating an example process for generating one or more selectors corresponding to the example form of FIG. 3, in accordance with one or more embodiments.

FIG. 5 depicts an example primary form utilized by an unregistered user, in accordance with one or more embodiments.

FIG. 6 depicts an example secondary form utilized by an unregistered user, in accordance with one or more embodiments.

FIG. 7 depicts a process diagram illustrating an example process for utilizing one or more selectors in the example primary form of FIG. 5, in accordance with one or more embodiments.

FIG. 8 depicts a flow diagram of an example process for generating one or more selectors, in accordance with one or more embodiments.

FIG. 9 depicts an example electronic system with which aspects of the present disclosure may be implemented, in accordance with one or more embodiments.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other embodiments. In one or more embodiments, structures and components are shown in block diagram form in order to avoid obscuring the concepts of the subject technology.

Web pages, or other data entry user interfaces, may provide a form for a user to provide information. In some cases, forms may include a secondary form for the user to complete, which may request overlapping information requested by the initial form. If a user is to complete multiple forms that request the same information, the user may be less likely to complete at least some of the forms due to the redundant efforts requested of the user.

For example, a first form from a merchant may request the user's phone number and payment information for checkout and may offer the user to save the payment information with a payment processor for subsequent checkouts. If the user agrees to save the payment information with the payment processor, the user may be presented with a second form to register for, or sign into, an account associated with the payment processor. Like the first form, the second form may also request that the user enter their phone number to identify the user, thus requiring redundant and/or duplicative efforts by the user.

Aspects of the subject technology provide autofill techniques for secondary web-based forms. A user may be completing a primary form in a web environment, such as a checkout form including payment and address information. The primary form may include an option that provides a secondary form in the web environment, such as an account registration form. The subject technology may provide a web browser with an autofill technique (e.g., via JavaScript code embedded within a webpage) to copy information from the primary form to the secondary form to reduce duplicative work performed by the user thereby reducing the friction in completing the secondary form and increasing the completion rate of the secondary form.

Aspects of the subject technology include building one or more field selectors based on known information about a user cross-referenced with the information provided to a primary form (e.g., by a user filling out the primary form). For example, when a user registered with the system accesses the primary form, the web browser of the user builds one or more selectors corresponding to one or more form fields based on a comparison between the information input by the user into the primary form and the user's information registered with the system (e.g., stored at the system and accessed via a cookie associated with the web browser of the user). When an unregistered user accesses the primary form, the web browser of the unregistered user may receive the previously generated selector(s) (e.g., via JavaScript embedded in a web page being processed by the web browser) that allows the web browser of the unregistered user to identify and copy information from the primary form (as identified by the selectors) over to the secondary form, so that the unregistered user does not have to manually re-enter the information.

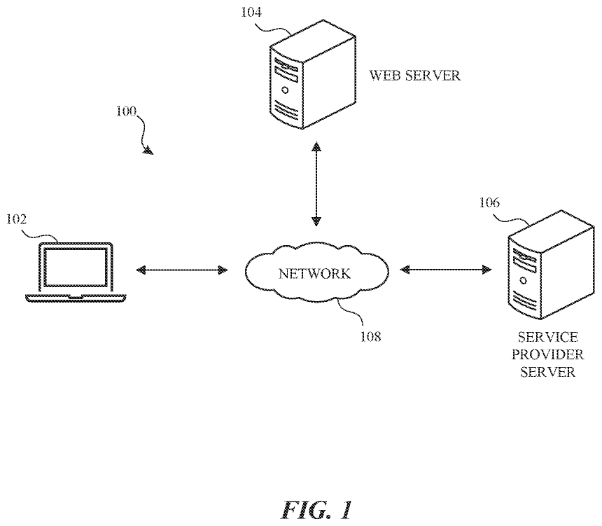

FIG. 1 illustrates an example network environment 100 in which the subject technology may be implemented, in accordance with one or more embodiments. Not all of the depicted components may be used in all embodiments, however, and one or more embodiments may include additional or different components than those shown in the figure. Variations in the arrangement and type of the components may be made without departing from the spirit or scope of the claims as set forth herein. Additional components, different components, or fewer components may be provided.

The network environment 100 may include an electronic device 102, a web server 104, and a service provider server 106. The network 108 may communicatively (directly or indirectly) couple one or more of the electronic device 102, the web server 104, and the service provider server 106. In one or more embodiments, the network 108 may be an interconnected network of devices that may include, or may be communicatively coupled to, the Internet.

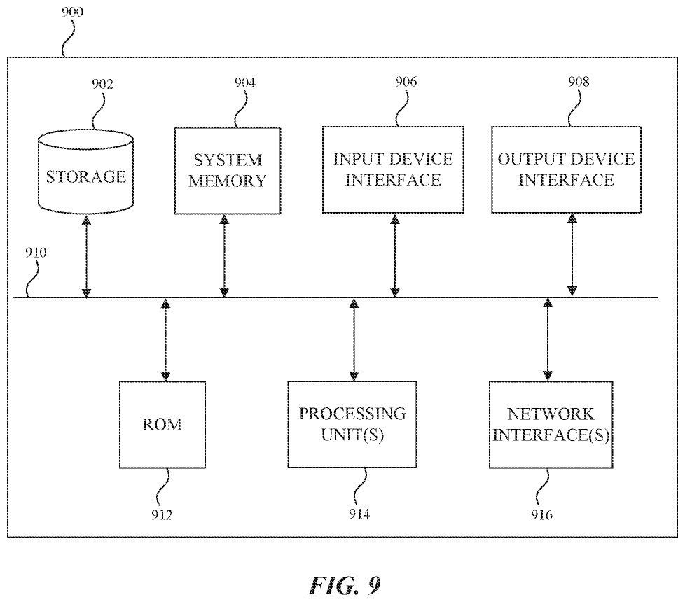

For explanatory purposes, the network environment 100 is illustrated in FIG. 1 as including the electronic device 102, the web server 104, and the service provider server 106; however, the network environment 100 may include any number of electronic devices and/or any number of servers communicatively coupled to each other directly or via the network 108. In addition, the various systems of FIG. 1 may be, and/or may include all or part of, the electronic system discussed below with respect to FIG. 9.

The electronic device 102 may be, for example, a wearable device (such as a watch, a band, and the like), a desktop computer, a portable computing device (e.g., a laptop computer), a smartphone, a peripheral device (e.g., a digital camera, headphones), a tablet device, or any other appropriate device that includes, for example, one or more wireless interfaces, such as WLAN radios, cellular radios, Bluetooth radios, Zigbee radios, near field communication (NFC) radios, and/or other wireless radios. In FIG. 1, by way of example, the electronic device 102 is depicted as a laptop computer. The electronic device 102 may be associated with one or more accounts, credentials, or any other identity information registered with the service provider server 106 belonging to a user associated with the electronic device 102.

The service provider server 106 may be and/or may include, for example, one or more servers that host or facilitate a service that may be used by one or more entities (e.g., the electronic device 102). For example, the service provider server 106 may belong to a payment processor, and the service may include a credit card processing platform that may integrate with one or more webpages. The service provider server 106 may store account information (e.g., user account, usernames/handles, or any other account-specific data) associated with the electronic device 102 and/or users thereof and/or users associated therewith. The service provider server 106 may also host one or more scripts (e.g., JavaScript scripts) that may be used by another server. For example, a web server 104 may embed a script, hosted by the service provider server 106, into a webpage that may be sent to a client so that the script may be run on the client via the webpage (e.g., cross-origin resource sharing). The service provider server 106 may also include a database, directory, mapping, or other data structure of selectors (e.g., HTML and/or CSS selectors) associated with a particular entity, server, form, and/or the like. The data structure storing the selectors may include one or more metrics corresponding to each selector, such as a success rate representing how often the selector identifies an item (e.g., on a document object model (DOM) of a webpage) and/or how often the selector correctly identifies an item (e.g., on a DOM of a webpage). The service provider server 106 may be, and/or may include all or part of, the electronic system discussed below with respect to FIG. 9.

The web server 104 may be and/or may include, for example, one or more servers that host or facilitate a service that may be used by one or more entities (e.g., the electronic device 102). For example, the web server 104 may belong to a merchant, and the service may include the sale and/or exchange of goods and/or services, which may be facilitated by one or more payment processors. The web server 104 may store account information (e.g., user account, usernames/handles, or any other account-specific data) associated with the electronic device 102 and/or users thereof and/or users associated therewith. The web server 104 may be, and/or may include all or part of, the electronic system discussed below with respect to FIG. 9.

The web server 104 may also generate one or more webpages that include one or more forms. In one or more embodiments, a form may be an interactive webpage element used to collect and/or submit data via a webpage. Forms may include one or more input elements, referred to herein as form fields or fields. Form fields can be identified in a webpage (e.g., via a DOM of a webpage) through characteristics of the form fields, such as an “id” attribute, “name” attribute, “type” attribute, webpage position (e.g., location in the DOM), and/or the like. A form field may have an “id” attribute that provides a unique identifier within the webpage, which can be used to directly access the field, for example, via JavaScript. A form field may have a “name” attribute that is used to associate a form field's value with a key when the form is submitted. A form field may have a “type” attribute that specifies the type of the form field, such as a text, radio, checkbox, and the like. A form field may be nested within the structure of a webpage (e.g., a DOM of an HTML document) and can be located by its position within the hierarchy (e.g., using parent-child or other familial relationships).

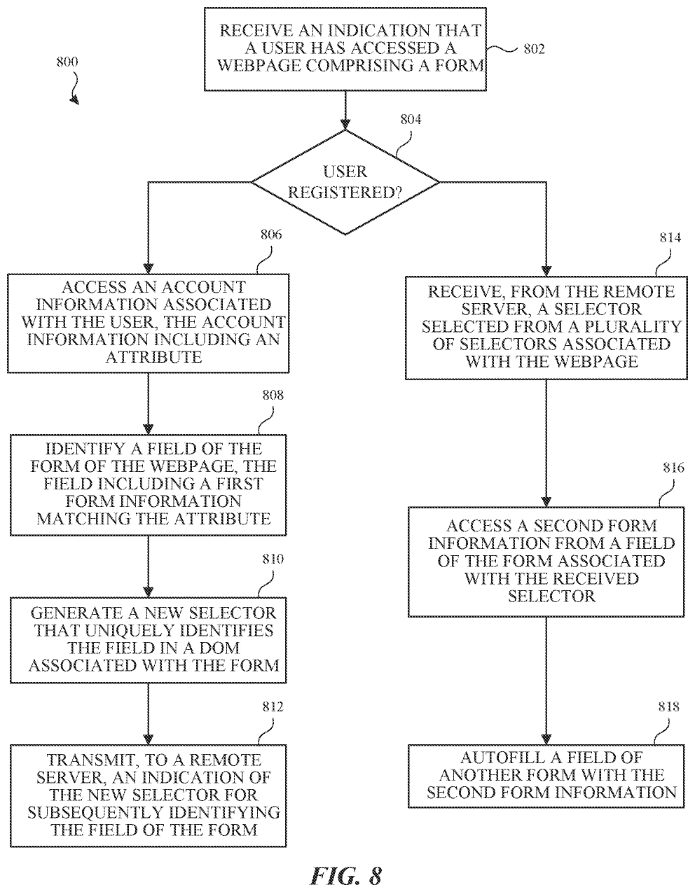

The one or more generated webpages may also include one or more scripts (e.g., scripts hosted by another server and embedded in a webpage). A script embedded in a webpage may cause an electronic device (e.g., the electronic device 102) to perform one or more operations described below with respect to FIG. 8. For example, the script may include instructions for generating one or more selectors. In one or more embodiments, a selector may be a mechanism (e.g., a CSS selector or any other field selector/indicator) used to identify specific elements within a webpage, such as a form field. In some examples, a CSS selector is used to identify one or more nodes in a DOM tree. In some examples, an alternative model may be used for creating a string that describes the path through a DOM tree. In some examples, CSS selectors may be used in combination with a DOM API such as document.querySelector( ) to capture a reference to one or more nodes in the DOM tree. A selector may be composed of characteristics (e.g., the “id” attribute, “name” attribute, “type” attribute, webpage position, and/or the like, of a form field) associated with one or more elements to be identified within a webpage. Selectors may be employed in conjunction with the script to dynamically interact with and manipulate the identified elements.

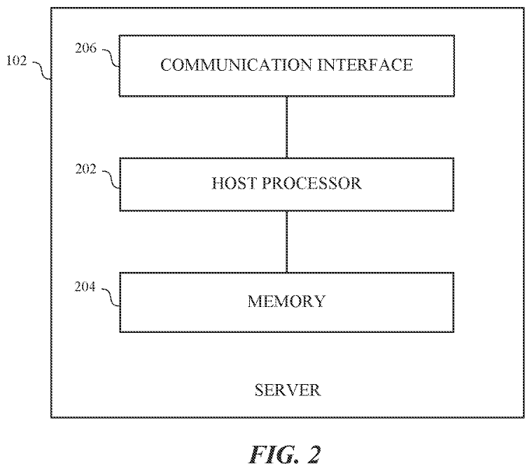

FIG. 2 depicts an example electronic device 102 that may implement the subject technology, in accordance with one or more embodiments. For explanatory purposes, FIG. 2 is primarily described herein with reference to the electronic device 102 of FIG. 1. However, this is merely illustrative, and features of the server of FIG. 2 may be implemented in any other electronic device for implementing the subject technology. Not all of the depicted components may be used in all embodiments, however, and one or more embodiments may include additional or different components than those shown in FIG. 2. Variations in the arrangement and type of the components may be made without departing from the spirit or scope of the claims as set forth herein. Additional components, different components, or fewer components may be provided.

The electronic device 102 may include one or more of a host processor 202, a memory 204, and/or a communication interface 206. The host processor 202 may include suitable logic, circuitry, and/or code that enable processing data and/or controlling operations of the electronic device 102. In this regard, the host processor 202 may be enabled to provide control signals to various other components of the electronic device 102. The host processor 202 may also control transfers of data between various portions of the electronic device 102. The host processor 202 may further implement an operating system or may otherwise execute code to manage operations of the electronic device 102.

The memory 204 may include suitable logic, circuitry, and/or code that enable storage of various types of information such as received data, generated data, code, and/or configuration information. The memory 204 may include volatile memory (e.g., random access memory (RAM)) and/or non-volatile memory (e.g., read-only memory (ROM), flash, and/or magnetic storage).

The communication interface 206 may include suitable logic, circuitry, and/or code that enables wired or wireless communication, such as between the electronic device 102, the web server 104, the service provider server 106, and/or the electronic device 102. The communication interface 206 may include, for example, one or more of a Bluetooth communication interface, an NFC interface, a Zigbee communication interface, a WLAN communication interface, a USB communication interface, a cellular interface, or generally any communication interface.

In one or more embodiments, one or more of the host processor 202, the memory 204, the communication interface 206, and/or one or more portions thereof may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

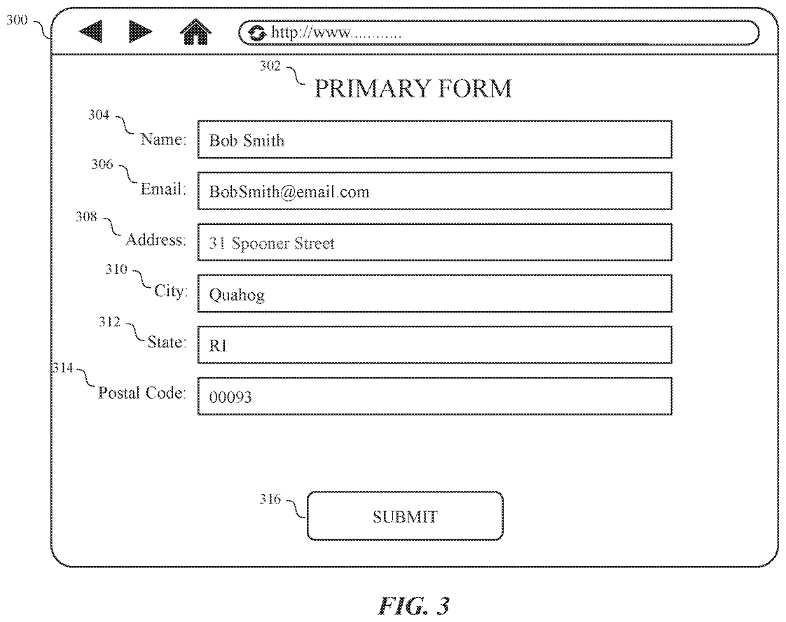

FIG. 3 depicts an example primary form 302 utilized by a registered user, in accordance with one or more embodiments. An application, such as a web browser 300, may render a webpage from a web server 104.

The webpage may include a primary form 302. The primary form 302 may be one or more user interface elements (e.g., form fields 304-314 and buttons 316) designed to collect information from users for various purposes such as transactions, registrations, submissions, inquiries, and/or the like. The primary form 302 may be integrated into websites, web applications, and/or other online platforms to enable streamlined data collection and user engagement.

The primary form 302 may include one or more form fields 304, 306, 308, 310, 312, 314 (collectively, form fields 304-314). Form fields may be interactive elements where users can input data, make selections, or provide responses. Depending on the field type, user inputs can range from simple text entries to complex selections or uploads. Types of form fields include text inputs, radio buttons, checkboxes, dropdown menus, date pickers, hidden fields, and the like. Each form field 304-314 may possess attributes and/or properties that define its behavior, appearance, and/or validation rules. Attributes may include “name,” “id,” “type,” and “value,” and may be used individually or in combination with selectors (e.g., CSS selectors or any other selector) to uniquely identify each form field 304-314.

When a user interacts with a form field 304-314 (e.g., enters text, makes a selection), the inputted data may be stored within the form field 304-314. The inputted data can be accessed, manipulated, and validated using JavaScript or other programming languages. When the user submits the form (e.g., via button 316), the data collected from form fields may be sent to the server (e.g., the web server 104) for processing, storage, or further actions.

In addition to the primary form 302, the webpage may also include scripts embedded in the webpage to enable dynamic interactions with primary form 302 and form data within the web browser 300. Embedded scripts may be written in programming languages such as JavaScript and may serve as executable code that can respond to user inputs, manipulate form elements, validate data, and trigger various actions based on the user's interactions. Embedded scripts may be hosted by and/or associated with one or more servers other than the server that provided the webpage.

When a webpage contains an embedded script, the embedded script may be loaded (e.g., retrieved from another server, such as the service provider server 106) and executed by the web browser 300 as part of the page rendering process. Embedded scripts may enable the automation of tasks related to form data. For example, when a user submits the primary form 302, the embedded script may access the user's account information associated with the service provider server 106 to compare with the form data of the primary form 302.

Embedded scripts may also facilitate the population of form fields using pre-existing data (e.g., data input by the user in another form). Populating form fields may be useful when dealing with multi-step forms or situations where some data has already been provided by the user. The script can automatically transfer data from one form field to another, reducing the need for users to repeatedly enter the same information.

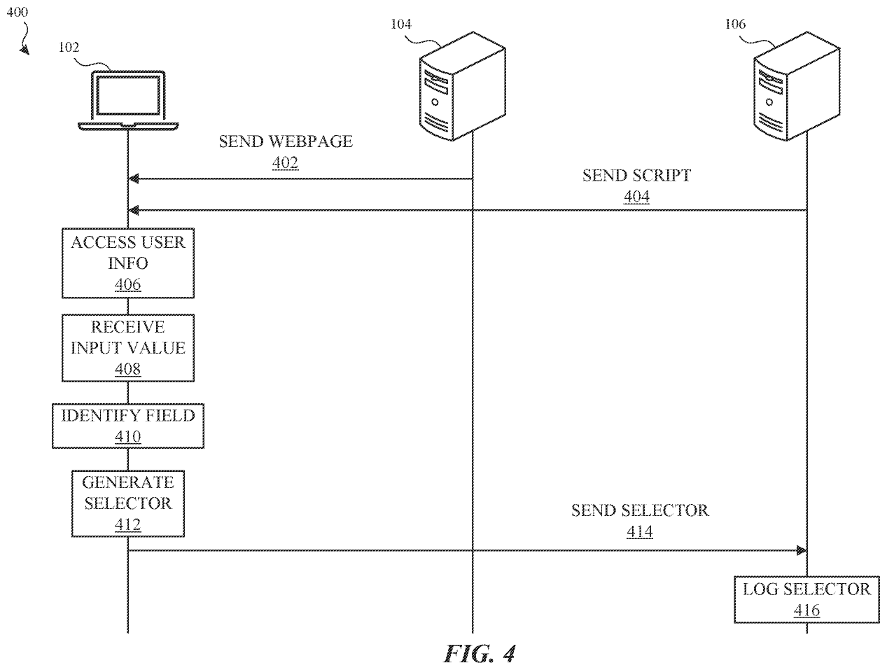

FIG. 4 depicts a process diagram 400 illustrating an example process for generating one or more selectors corresponding to the example form of FIG. 3, in accordance with one or more embodiments.

When a user enters a uniform resource locator (“URL”) or clicks on a link in the web browser 300, for example, the web browser 300 sends a request to the corresponding web server 104 hosting the requested webpage. In response, the web server 104 processes the request and generates code for a webpage that may contain various elements, such as HTML markup, CSS styles, images, and scripts. The webpage is then sent back to the user's device as a response to the request (402).

Upon receiving the code for the webpage, the web browser 300 may render the webpage, including the form and script, allowing the user to interact with the provided elements directly from the user device. Rendering the content of the webpage may include retrieving any resources (e.g., images, scripts, and/or the like) linked in the webpage (404). For example, the web page may include a link to a script that is hosted by the service provider server 106, and the web browser 300 may retrieve the script from the service provider server 106. In some examples, the script and the selectors may be provided with the webpage.

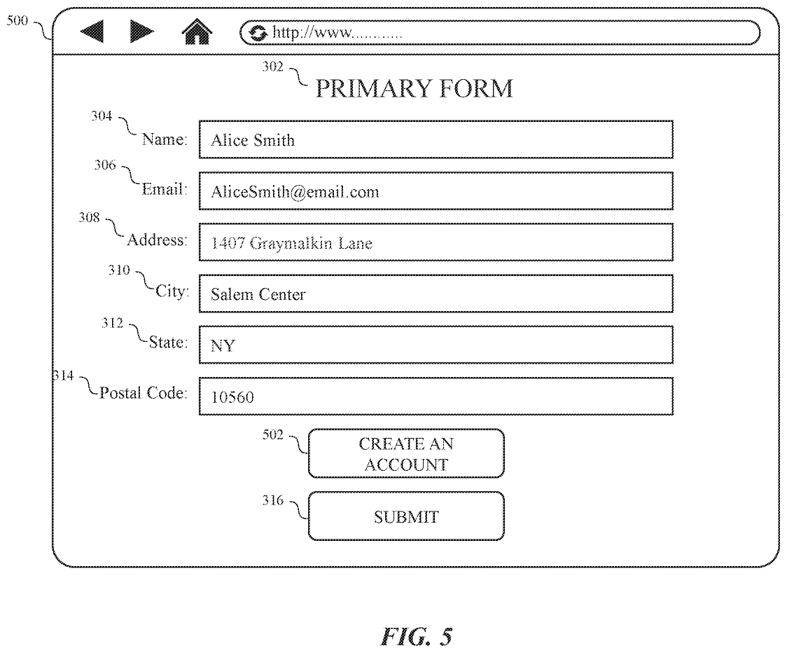

The script (e.g., running on the web browser 300 on the electronic device 102) may cause the web browser 300 to attempt to access the information of the user (406). The script may execute within the web browser 300 and determine whether the user is logged into an account registered with the service provider server 106 (e.g., by checking for an authentication token (e.g., cookie or one-time password (OTP)) related to the service provider server 106 stored in association with the web browser 300). If the user is logged into an account registered with the service provider server 106, then the script may access the information (e.g., an email) of the user (e.g., on the service provider server 106) and proceed with generating one or more selectors according to the process diagram 400. Otherwise, the script may proceed with processes described with respect to FIGS. 5-7.

In some examples, the authentication token may include user information, such as an email. In some examples, the authentication token may also or instead be used by the script to initiate a request (e.g., an asynchronous request) to the service provider server 106 for the information of the user. The request may include the authentication token (e.g., cookie or OTP), which acts as a credential to access the resources of the service provider server 106. The service provider server 106 may respond with the information associated with the user, such as an email associated with the user.

The web browser 300 may receive form input values (408) as the primary form 302 becomes completed. For example, the user may manually input information into one or more form fields 304-314.

After the input values are received in one or more form fields 304-314 and/or when the primary form 302 is submitted, the script may cause the web browser 300 to identify (e.g., locate in the form) one or more target form fields for which one or more selectors may be generated (410). The target form fields for which selectors are generated may be commonly found in various forms, such as email, address, or postal code, and may be pre-defined and/or specified in the script, for example. In some embodiments, the target form fields may be identified by name or other information associated with the form field. For example, if the target form field is the email form field 306, the script may look for a text field named “email” (e.g., by the “name” attribute of the HTML element), a text field including information that represents an email (e.g., as determined by a regular expression), a text field that includes information matching the email of the registered user (e.g., as obtained via the authentication token of the registered user), and/or the like. In some examples, because form fields 304-314 may not always be named or otherwise labeled according to the information they are associated with, the script may cause the web browser 300 to traverse the DOM of the webpage to identify the target form fields.

When a target form field is identified, one or more selectors may be generated (412) for the target form field so that the target form field may be uniquely and directly identified (e.g., without traversing the DOM) with a selector. In some examples, multiple selectors may be created for each individual field along with a weighting of each of the selectors based on the frequency in which they are received. This is important when generating selectors algorithmically so that the system can determine which selectors are most appropriate to use in the future. In some examples it is difficult to create a unique selector that is likely to be resilient to changes that are made to the fields on a website.

There are a variety of strategies to create a unique selector. It is important to consider the tradeoffs between the stability of the selector and the likelihood that they work across different user sessions. The one or more selectors for each target form field may be generated according to one or more strategies. In one embodiment, generating a unique selector may include describing the full path from the root node of the DOM to the target form field. This may look like traversing the body>div:nth-child(3)>div:nth-child(1)>div:nth-child(1)>form>div:nth-child(4)>input. This traversal has a high likelihood of success until the merchant makes changes to the website, which may change the path. In some examples even a small change to the website may cause a break in the path. In some examples, if different users have different page states that may cause the path to change, this may also result in the path to fail. One mitigation is to receive selectors from different logged in users during each of the states to address different page states and improve the successful traversal of a path.

In another embodiment, generating a unique selector may include describing the path from the nearest unique identifier (e.g., nearest “id” attribute to the target form field). In some examples, this is more likely to be successful if the id has a semantic meaning (e.g., #user-email, #phone-field) than if it were autogenerated or lacked semantic meaning (e.g., #sdf34). In some embodiments, using the nearest id may be less useful if the id is non-static (e.g., generated at runtime).

In some embodiments, when selectors are sent, the frequency in which the selector is selected may be tracked and used to weight the selector for future selection. In some embodiments, when sending selectors for non-logged in users, the selectors that have the highest frequency of use may be selected with a bias for selectors that are more recently used. Selecting selectors based on frequency and recency help to ensure a higher level of accuracy to avoid incorrect prefills and efficiency in enabling prefills often. In some embodiments, machine learning models may be incorporated to provide a more effective heuristic for developing selectors. In some examples, a machine learning based model may analyze a full path and determine the relevant selectors in the path that are stable and accurate for use. In some examples, it is beneficial to create multiple selectors and measure the frequency in which any specific selector is used to ensure accuracy and correctness.

The script may cause the web browser 300 to send (e.g., synchronously or asynchronously) the one or more generated selectors for each target form field to the service provider server 106 (414).

The service provider server 106 may log the one or more generated selectors for each target form field of the form (416). For example, the service provider server 106 may receive and store the one or more generated selectors associated with the primary form 302 and may maintain a frequency (e.g., a count over a predetermined period of time) that each selector is received for a particular target form field of the form.

FIG. 5 depicts an example primary form 302 utilized by an unregistered user (e.g., a user not logged into an account associated with the secondary form and/or an account registered with the service provider server 106), in accordance with one or more embodiments. An application, such as a web browser 500, may render a webpage from the web server 104. The web browser 500 may be the same as the web browser 300 and/or may be running on the same electronic device as the web browser 300.

When the webpage of the primary form 302 is loaded, the script of the webpage may be executed by the web browser 500. The script may cause the web browser 500 to determine that the user is not logged into an account registered with the service provider server 106 (e.g., by determining that the web browser 500 does not include an authentication token associated with the user). As a result, the script may cause the web browser 500 to provide an option to register or log into an account associated with the service provider server 106. For example, as shown in FIG. 5, the web browser 500 provides a button 502 that may render, initialize, or otherwise provide, a secondary form for registering with the service provider server 106.

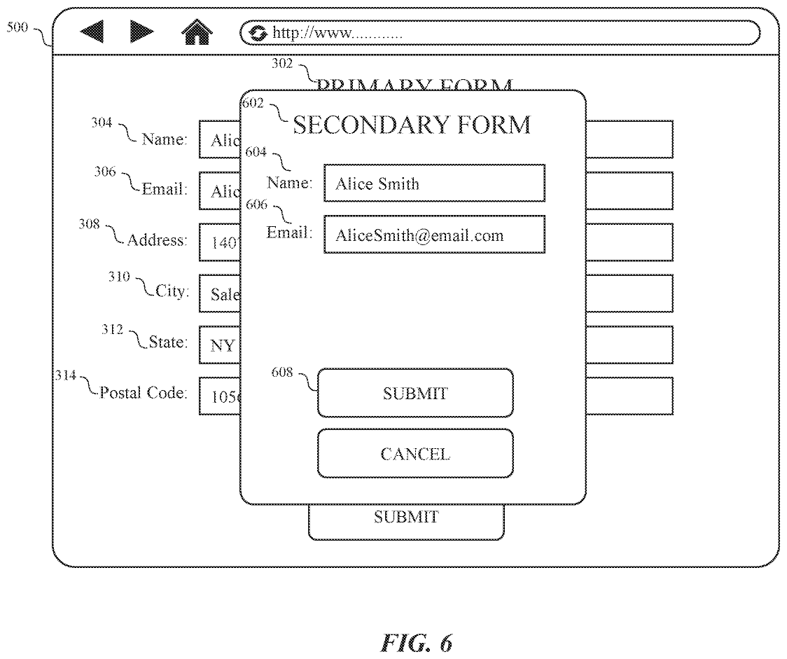

FIG. 6 depicts an example secondary form 602 utilized by an unregistered user (e.g., a user not logged into an account associated with the secondary form and/or an account registered with the service provider server 106), in accordance with one or more embodiments. The secondary form 602 may be and/or may include one or more user interface elements as described above with respect to the primary form 302. The secondary form 602, when submitted (e.g., via button 608), may provide the information input into the form fields 604, 606 to the service provider server 106 (e.g., to register the user with the service provider server 106).

The script may cause the web browser 500 to request, download, receive, or otherwise obtain one or more selectors associated with the primary form 302. The one or more selectors may have been generated by a web browser (e.g., the web browser 300) when a user registered with the service provider server 106 interacts with (e.g., completes) the primary form 302.

The script may cause the web browser 500 to obtain information input by the user into one or more of the form fields 304-314 and provide the information to one or more of the corresponding form fields 604, 606. For example, the script may cause the web browser 500 to locate the name form field 304 and copy contents of the form field 304 into the name form field 604 so that the user does not need to re-enter their name.

In some examples, the web browser 500 may receive the one or more selectors from the service provider server 106 when the web browser 500 receives the script.

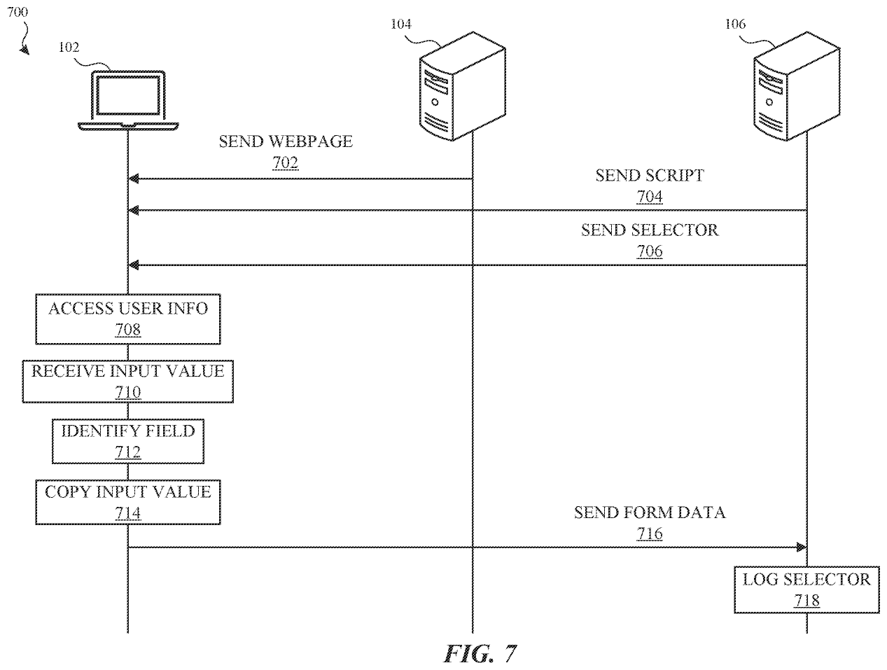

FIG. 7 depicts a process diagram 700 illustrating an example process for utilizing one or more selectors in the example primary form of FIG. 5, in accordance with one or more embodiments.

When a user enters a URL or clicks on a link in the web browser 500, for example, the web browser 500 sends a request to the corresponding web server 104 hosting the requested webpage. In response, the web server 104 processes the request and generates code for a webpage that may contain various elements, such as HTML markup, CSS styles, images, and scripts. The webpage is then sent back to the user's device as a response to the request (702).

Upon receiving the code for the webpage, the web browser 500 may render the webpage, including the form and script, allowing the user to visually interact with the provided elements directly from their device. Rendering the content of the webpage may include downloading, retrieving, or otherwise obtaining any resources (e.g., images, scripts, and/or the like) linked in the webpage. For example, the web browser 500 may receive a script from the service provider server 106 (704). The web browser 500 may also receive one or more selectors associated with the primary form 302 from the service provider server 106 (706). One or more selectors may be received for each target form field. In some embodiments, for each target form field, the one or more selectors may be selected from a plurality of selectors corresponding to a target form field based on how frequently they are seen (e.g., received and stored by the service provider server 106) and/or how successfully they identify the target form field (e.g., they identify a form field and the identified form field is the target form field). For example, the service provider server 106 may weigh each of the plurality of selectors corresponding to a target form field according to how frequently each selector is seen and may send to the web browser 500 the selectors that have a weight above a threshold level. In some embodiments, the one or more selectors may also or instead be selected from a plurality of selectors based on how recently they have been seen (e.g., received and stored by the service provider server 106). For example, the service provider server 106 may weigh the plurality of selectors corresponding to a target form field according to how recently each selector is seen and may send to the web browser 500 the selectors weighed above a threshold level. In some embodiments, a variety of strategies may be utilized to select a unique selector that will be resilient to changes a merchant may make on a website and will be likely to work across user sessions.

In some examples, the script and the selectors may be provided with the webpage.

The script (e.g., running on the web browser 500 on the electronic device 102) may cause the web browser 500 to attempt to access the information of the user (708). The script may execute within the web browser 500 and determine whether the user is logged into an account registered with the service provider server 106 (e.g., by checking for an authentication token (e.g., cookie or OTP) related to the service provider server 106 and stored in association with the web browser 500). If the user is not logged into an account registered with the service provider server 106, then the script may prepare to autofill one or more forms based on the one or more selectors. Otherwise, the script may proceed with processes described with respect to FIGS. 3-4.

The web browser 500 may receive form input values (710) as the primary form 302 becomes completed. For example, the user may manually input information into one or more form fields.

If the user decides to register with the service provider server 106 while completing the primary form 302 (e.g., by interacting with button 608), the web browser 500 may render, enable, activate, or otherwise make available, the secondary form 602 associated with the service provider server 106 and presented with (e.g., alongside, inline, overlayed, etc.) the primary form 302 in the web browser 500. When the secondary form 602 is made available, the script may cause the web browser 500 to utilize one or more of the received selectors to identify one or more target form fields of the form fields 304-314 (712). As shown in FIG. 6, the target form fields are form fields 304, 306, which correspond to form fields 604, 606. Because the received selectors uniquely identify the target form fields 304, 306 of the primary form 302, the script does not need to traverse the DOM but can instead refer directly to the target form fields 304, 306.

When the target form fields 304, 306 are identified, the script may cause the web browser 500 to copy the values of the form fields 304, 306 and autofill (e.g., paste) the copied values into the form fields 604, 606 so that the user does not need to re-enter the same information. In examples in which multiple selectors were received for a target form field, the form field of the secondary form 602 may not be autofilled unless most (e.g., a majority) or all of the multiple received selectors for the target form field identify the same value, so as to avoid autofilling an incorrect value and causing the user to perform more work in completing the secondary form 602 (e.g., to correct incorrect input values). In other examples in which multiple selectors were received for a target form field, some or all of the multiple selectors may identify the value of the target form field but only a primary selector (e.g., having a highest success rate of the multiple selectors) may autofill the value into the secondary form 602, for example, to test the efficacy of the non-primary selectors.

In some examples, the script may also cause the web browser 500 to update the values of the form fields 604, 606 with any changes in the values of the target form fields 304, 306. For example, the script may detect a change in the target form field 304 and, responsive to the detected change, may update the value of the form field 604 accordingly. In some examples, autofilling (712 and 714) may occur before the secondary form 602 is available to the user (e.g., while the form fields 604, 606 are present in the DOM but invisible to the user).

The user may complete the secondary form 602, which may include inputting values into form fields that were not autofilled and/or changing (e.g., correcting) autofilled input values. If the user changes an autofilled value, the script may cause the web browser 500 to generate an indication (e.g., a note, flag, and/or the like) associated with the relevant selector that the autofilling was not successful. If the user changes an autofilled value to a value that was identified by another received selector, the script may cause the web browser 500 to generate an indication associated with the other received selector that the autofilling would have been successful if the other selector had been utilized.

When the user submits the secondary form 602 (e.g., via button 608), the web browser 500 may send the form data of the secondary form 602 to the service provider server 106 (716). The form data may include input values to the form fields 604, 606 (e.g., autofilled, manually entered, etc.). The form data may also include any indications that were generated in association with one or more of the received selectors, such as whether a selector identified an item and whether a selector correctly identified an item. The user may return to completing the primary form 302.

When the service provider server 106 receives the form data, the service provider server 106 may log (718) the indications that were generated in association with one or more of the selectors utilized by the web browser 500. Logging the indications may include updating a success rate of each selector that was utilized, where the success rate may indicate the number of successful autofills (e.g., an autofilled input value to a form field that was not changed by the user) over a period of time. For example, if the form data indicates that a selector was (or would have been) utilized in association with an unsuccessful autofill, then the success rate of the selector may be reduced, and if the form data indicates that a selector was (or would have been) utilized in association with a successful autofill, then the success rate of the selector may be increased. This way, when the primary form 302 is subsequently accessed by an unregistered user, the service provider server 106 may provide one or more selectors based on an updated success rate of the one or more selectors.

FIG. 8 depicts a flow diagram of an example process 800 for generating one or more selectors, in accordance with one or more embodiments. For explanatory purposes, the process 800 is primarily described herein with reference to the electronic device 102, the web server 104, and the service provider server 106 of FIG. 1. However, the process 800 is not limited to the electronic device 102, the web server 104, and the service provider server 106, and one or more blocks of the process 800 may be performed by one or more other by other suitable devices. Further, for explanatory purposes, the blocks of the process 800 are described herein as occurring sequentially or linearly. However, multiple blocks of the process 800 may occur in parallel. In addition, the blocks of the process 800 need not be performed in the order shown and/or one or more blocks of the process 800 need not be performed and/or can be replaced by other operations.

At block 802, a web browser running on a user device (e.g., the electronic device 102) may receive an indication that a user has accessed a webpage that includes a form (e.g., the primary form 302). Receiving the indication may involve, for example, tracking user actions (e.g., the user clicks a link to the page or enters the URL to the page) or monitoring network requests (e.g., the web browser generates a network request for the page). The form may be associated with a first server (e.g., the web server 104) and may include one or more sub-forms, at least one of which may be associated with a second server (e.g., the service provider server 106). For example, the form may be a checkout page of an online merchant and the sub-form may be a registration form for a third-party payment processor.

At block 804, receiving an indication that the user has accessed the webpage that includes the form may trigger the web browser to determine whether the user is registered with a remote server (e.g., the service provider server 106). When or before the user accesses the webpage, the web browser may receive an authentication token, such as a cookie or OTP, to determine whether the user is registered with the remote server (e.g., logged into an account registered with the remote server). If the web browser determines that the user is not registered with the remote server, the process 800 may proceed to block 806; otherwise, the process may proceed to block 814.

At block 806, the web browser may request, receive, retrieve, extract, or otherwise access account information associated with the user. The account information may include an attribute such as a name, email, and/or any other information associated with the user's registration with the remote server.

For example, a browser cookie associated with the remote server may include an email associated with the user's registration with the remote server. As another example, the web browser may utilize the authentication token to request and receive a postal code associated with the user's registration with the remote server.

At block 808, the web browser may identify a field in the form of the webpage. The field may include a first form information matching the account information, which may have been input into the field by the user. Because the web browser does not have a selector that identifies the field, the identification may be achieved by employing techniques such as Regular Expressions (regex) (e.g., to identify patterns that resemble information such as an email) or text string searches (e.g., that directly search for the account information). For example, to identify a form field for entering an email, a regular expression may include /[a-z0-9]+@[a-z]+\.[a-z]{2,3}/ and a text string search may be for the email associated with the user.

Additionally or alternatively, the web browser may identify the field by attributes associated with the field. The web browser may utilize field attributes such as “id” and “name” attributes, which provide unique identifiers for form elements. For example, to find a phone number field, the web browser may search for form elements having an “id” attribute and/or “name” attribute that is “phone,” “phone number,” and/or the like.

At block 810, the web browser may generate a new selector that uniquely identifies the field in the DOM. The generated selector may serve as an identifier to accurately and reliably pinpoint the desired form field among other elements in the webpage's structure. Although only one new selector is discussed, it is contemplated that any number of selectors may be generated for any number of form fields.

To generate a new selector, the web browser may engage in an analysis of the DOM, which represents the webpage's content and structure. In scenarios where standard attributes like “id” or “name” are insufficient or unavailable for uniquely identifying the form field, the web browser can dynamically generate a selector using a combination of attributes, element types, classes, and/or any other CSS or CSS-like identifiers.

Generating a new selector may involve evaluating various classes and/or attributes associated with the form field, such as labels, placeholder text, or data attributes. The attributes may then be used to construct a selector that encapsulates the specific set of criteria required to uniquely identify the form field within the DOM. For example, the generated selector may resemble a CSS selector and include a full path from the root of the webpage (e.g., body>div:nth-child(2)>div:nth-child(3)>form>div:nth-child(1)>div:nth-child(1)>input), a path from the root to the nearest ancestor with a single input (e.g., body>div:nth-child(2)>div:nth-child(3)>form>div:nth-child(1) input), the nearest ID (e.g., #email>input) the nth form to the nth input (e.g., form:at(0) input:at(2)), the nearest ancestor with a unique class list (e.g., form-component.email-input>input), the unique attributes of a targeted input (e.g., input[name=email][id=email-input]), and the like.

Additionally or alternatively, generating a new selector may involve evaluating the position of the form field in the DOM. The position and/or attributes may then be used to construct a selector that encapsulates the specific set of criteria required to uniquely identify the form field within the DOM. For instance, position may include a path from a root of the DOM to the target field or an ancestor thereof, a path from a unique parent element (e.g., path from an “id” attribute of a parent element, an ordinal position of children of the parent element, etc.), a path from a unique sibling element (e.g., path from an “id” attribute of a sibling element, an ordinal position among the sibling elements), and/or any other path within the DOM.

At block 812, the web browser may transmit an indication (e.g., the new selector or a representation thereof) of the new selector to the remote server for subsequently identifying the target field. The indication may include a unique identifier (e.g., the selector and/or an identifier representing the selector) for the remote server to track the success rate of the selector.

In some embodiments, the transmitting may be performed in response to submission of the form.

In some embodiments, a scraping server (e.g., a device different from the user device) may traverse through one or more webpages, including the webpage having the form, to scan each webpage and generate one or more selectors for one or more fields of any forms present on each webpage, in addition to or instead of generating selectors via the web browser as described in blocks 806-810. The scraping server may transmit the generated selectors to the remote server for subsequently identifying the target field.

At block 814, the web browser may receive a selector from a remote server (e.g., the service provider server 106). The remote server, based on prior interactions and assessments, may maintain a collection of selectors that have been used to identify target form fields in a form (e.g., an email field in the primary form 302), where the target form fields correspond to a form field of another form (e.g., an email field in the secondary form 602). Each selector may be associated with a success rate, indicating how often it has correctly pinpointed the intended form field within the DOM. The higher the success rate, the more reliable the selector is in accurately identifying the field.

The received selector may be identified by the remote server from a plurality of selectors, each related to the webpage's form field identification. Each selector may correspond to a distinct success rate, denoting the effectiveness of the selector in accurately identifying the form field within the DOM. The received selector may be a selector that has the highest success rate compared to the rest of the selectors in the plurality of selectors.

In some embodiments, multiple selectors may be identified by the remote server and received by the web browser. The multiple received selectors may be, for example, the selectors with the highest success rates compared to the rest of the selectors in the plurality of selectors.

In some embodiments, the remote server may use one or more machine learning models to identify the selectors by, for example, predicting the most likely set of selectors to be used based on training data such as historical data and/or contextual data. Historical data may include attributes of the primary form such as field names, field types, page URL, and/or other metadata corresponding to the selectors used to successfully transfer data to the secondary form. Similarly, contextual data may include user interactions, such as time spent on form, order of data entry, and/or the type of device used, corresponding to the selectors used to successfully transfer data to the secondary form. One type of machine learning model for choosing selectors may be a deep neural network (DNN). When training the DNN, the DNN may ingest the features from the dataset and attempt to predict the corresponding selector. Over time and with enough data, the DNN may fine-tune its weights to accurately predict which selectors to provide to the web browser.

In some embodiments, the machine learning model may be provided real-time data about the primary form as users interact with the primary form. For example, the web browser may asynchronously (e.g., without having to refresh the page) provide real-time data to the remote server after the form has been rendered, and the remote server may asynchronously return one or more selectors identified by the machine learning model to the web browser. The machine learning model may then predict the most appropriate selectors for data transfer to the secondary form. Such a machine learning-based approach may allow the autofill system to adapt to changing web environments, user behaviors, and form structures, reducing the friction and redundancy users may face when interacting with sequential (e.g., nested, embedded, etc.) web forms, which may result in higher form completion rates.

At block 816, the web browser may access the values of a form field for each received selector. The selector acts as a guide, directing the web browser to the location of the target form field.

At block 818, the web browser may automatically fill (e.g., autofill) a field of another form (e.g., the secondary form 602) with a value from block 816. If a single selector was received, the web browser may autofill the field of the other form with the value retrieved according to the single selector. In some examples, if the web browser autofills the field of the other form and the user does not change the value of the field of the other form, the web browser may generate an indication (e.g., record, flag, etc.) that the autofill was successful. The indication may include a unique identifier (e.g., the selector and/or an identifier associated with the selector) and be sent to the remote server to cause the remote server to increase a success rate of the single selector associated with the unique identifier. Conversely, if the autofill was not successful the remote server may decrease a success rate of the single selector (e.g., via the indication including the unique identifier to be sent to the remote server).

If multiple selectors were received, the web browser may autofill the field of the other form with the value retrieved according to one of the multiple selectors when most (e.g., a majority) or all of the multiple selectors direct the web browser to retrieve the same value. In some examples, if the retrieved values are different between selectors, the web browser may not autofill.

In some examples, if a first selector (e.g., a selector with a highest success rate) results in a selection of a value that is different than that resulting from a second selector (e.g., a selector with a second highest success rate), the values resulting from the first selector and the second selector may be compared to a value resulting from a third selector (e.g., a selector with a third highest success rate). The web browser may generate an indication (e.g., flag, instruction, etc.) that causes the remote server to increase the success rate of the selector (e.g., the first or second selector) that selects the same value as the third selector. The web browser may also or instead generate an indication (e.g., flag, instruction, etc.) that causes the remote server to decrease the success rate of the selector (e.g., the first or second selector) that selects a different value than the third selector.

FIG. 9 depicts an example electronic system 900 with which aspects of the present disclosure may be implemented, in accordance with one or more embodiments. The electronic system 900 can be, and/or can be a part of, any electronic device for generating the features and processes described in reference to FIGS. 1-8, including but not limited to a laptop computer, tablet computer, smartphone, and wearable device (e.g., smartwatch, fitness band). The electronic system 900 may include various types of computer-readable media and interfaces for various other types of computer-readable media. The electronic system 900 includes one or more processing unit(s) 914, a persistent storage device 902, a system memory 904 (and/or buffer), an input device interface 906, an output device interface 908, a bus 910, a ROM 912, one or more processing unit(s) 914, one or more network interface(s) 916, and/or subsets and variations thereof.

The bus 910 collectively represents all system, peripheral, and chipset buses that communicatively connect the numerous internal devices of the electronic system 900. In one or more embodiments, the bus 910 communicatively connects the one or more processing unit(s) 914 with the ROM 912, the system memory 904, and the persistent storage device 902. From these various memory units, the one or more processing unit(s) 914 retrieves instructions to execute and data to process in order to execute the processes of the subject disclosure. The one or more processing unit(s) 914 can be a single processor or a multi-core processor in different embodiments.

The ROM 912 stores static data and instructions that are needed by the one or more processing unit(s) 914 and other modules of the electronic system 900. The persistent storage device 902, on the other hand, may be a read-and-write memory device. The persistent storage device 902 may be a non-volatile memory unit that stores instructions and data even when the electronic system 900 is off. In one or more embodiments, a mass-storage device (such as a magnetic or optical disk and its corresponding disk drive) may be used as the persistent storage device 902.

In one or more embodiments, a removable storage device (such as a floppy disk, flash drive, and its corresponding disk drive) may be used as the persistent storage device 902. Like the persistent storage device 902, the system memory 904 may be a read-and-write memory device. However, unlike the persistent storage device 902, the system memory 904 may be a volatile read-and-write memory, such as RAM. The system memory 904 may store any of the instructions and data that one or more processing unit(s) 914 may need at runtime. In one or more embodiments, the processes of the subject disclosure are stored in the system memory 904, the persistent storage device 902, and/or the ROM 912. From these various memory units, the one or more processing unit(s) 914 retrieves instructions to execute and data to process in order to execute the processes of one or more embodiments.

The bus 910 also connects to the input device interfaces 906 and output device interfaces 908. The input device interface 906 enables a user to communicate information and select commands to the electronic system 900. Input devices that may be used with the input device interface 906 may include, for example, alphanumeric keyboards, touch screens, and pointing devices. The output device interface 908 may enable the electronic system 900 to communicate information to users. For example, the output device interface 908 may provide the display of images generated by electronic system 900. Output devices that may be used with the output device interface 908 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information. One or more embodiments may include devices that function as both input and output devices, such as a touchscreen. In these embodiments, feedback provided to the user can be any form of sensory feedback, such as visual feedback, auditory feedback, or tactile feedback; and input from the user can be received in any form, including acoustic, speech, or tactile input.

The bus 910 also couples the electronic system 900 to one or more networks and/or to one or more network nodes through the one or more network interface(s) 916. In this manner, the electronic system 900 can be a part of a network of computers (such as a local area network, a wide area network, an Intranet, or a network of networks, such as the Internet). Any or all components of the electronic system 900 can be used in conjunction with the subject disclosure.

Embodiments within the scope of the present disclosure can be partially or entirely realized using a tangible computer-readable storage medium (or multiple tangible computer-readable storage media of one or more types) encoding one or more computer-readable instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more embodiments, the tangible computer-readable storage medium can be directly coupled to a computing device, while in other embodiments, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessors or multi-core processors that execute software, one or more embodiments are performed by one or more integrated circuits, such as ASICs or FPGAs. In one or more embodiments, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon design preferences, it is understood that the specific order or hierarchy of blocks in the processes may be re-arranged, or that all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together into a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refers to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more embodiments, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, one or more implementations, an embodiment, the embodiment, another embodiment, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
receiving an indication that a user has accessed a webpage comprising a form;
responsive to determining that the user is registered with a remote server:
accessing an account information associated with the user, the account information including an attribute;
identifying a field of the form of the webpage, the field including a first form information matching the attribute;
generating a new selector that uniquely identifies the field in a document object model (DOM) associated with the form; and
transmitting, to a remote server, an indication of the new selector for subsequently identifying the field of the form; and
responsive to determining that the user is not registered with the remote server:
receiving, from the remote server, a selector selected from a plurality of selectors associated with the webpage, wherein each respective selector of the plurality of selectors is associated with a respective success rate indicating how frequently the respective selector correctly identified the field in the DOM, and the received selector is associated with a highest success rate relative to the plurality of selectors;
accessing a second form information from a field of the form associated with the received selector; and
autofilling a field of another form with the second form information.

2. The method of claim 1, wherein the transmitting is performed in response to a submission of the form.

3. The method of claim 1, wherein generating the new selector comprises at least one of the following:
generating a path from a root of the DOM to the field;
generating a path from a unique parent element to the field;
generating a path from a unique sibling element to the field;
generating a class list associated with the field; or
generating an attribute list associated with the field.

4. The method of claim 1, further comprising, before autofilling the field of the other form:
receiving, from the remote server, another selector from the plurality of selectors associated with the webpage; and
accessing a third form information from a field of the form associated with the other received selector.

5. The method of claim 4, wherein, autofilling the field of the other form with the second form information comprises:
comparing the second form information with the third form information;
in response to the second form information being the same as the third form information, autofilling the field of the other form with the second form information; and
in response to the second form information not being the same as the third form information:
receiving a fourth form information input into the field of the other form; and
in response to the second form information being the same as the fourth form information, transmitting, to the remote server, an indication that increases a success rate of the received selector; and
in response to the third form information being the same as the fourth form information, transmitting, to the remote server, an indication that increases a success rate associated with the other received selector.

6. The method of claim 1, further comprising:
in response to the autofilling, determining whether the field of the other form includes the second form information;
in response to determining that the field of the other form includes the second form information, transmitting, to the remote server, an indication that increases a success rate associated with the selector; and
in response to determining that the field of the other form does not include the second form information, transmitting, to the remote server, an indication that decreases the success rate associated with the selector.

7. The method of claim 1, wherein accessing the account information associated with the user comprises extracting the account information from a browser cookie.

8. An electronic device comprising:
a memory; and
a processor configured to:
receive an indication that a user has accessed a webpage comprising a form;
responsive to determining that the user is registered with a remote server:
access an account information associated with the user, the account information including an attribute;
identify a field of the form of the webpage, the field including a first form information matching the attribute;
generate a new selector that uniquely identifies the field in a document object model (DOM) associated with the form; and
transmit, to a remote server, an indication of the new selector for subsequently identifying the field of the form; and
responsive to determining that the user is not registered with the remote server:
receive, from the remote server, a selector selected from a plurality of selectors associated with the webpage, wherein each respective selector of the plurality of selectors is associated with a respective success rate indicating how frequently the respective selector correctly identified the field in the DOM, and the received selector is associated with a highest success rate relative to the plurality of selectors;
access a second form information from a field of the form associated with the received selector; and
autofill a field of another form with the second form information.

9. The electronic device of claim 8, wherein the transmitting is performed in response to a submission of the form.

10. The electronic device of claim 8, wherein generating the new selector comprises at least one of the following:
generating a path from a root of the DOM to the field in the DOM;
generating a path from the root of the DOM to a nearest ancestor with a single input relative to the field in the DOM;
generating a path to a nearest ID attribute named according to the field;
generating a class list associated with the nearest ancestor relative to the field, the nearest ancestor having a unique class list; or
generating an attribute list associated with the field, the field having a unique attribute list.

11. The electronic device of claim 8, wherein the processor is also configured to, before autofilling the field of the other form:
receive, from the remote server, another selector from the plurality of selectors associated with the webpage; and
access a third form information from a field of the form associated with the other received selector.

12. The electronic device of claim 11, wherein, autofilling the field of the other form with the second form information comprises:
comparing the second form information with the third form information;
in response to the second form information being the same as the third form information, autofilling the field of the other form with the second form information; and
in response to the second form information not being the same as the third form information:
receiving a fourth form information input into the field of the other form; and
in response to the second form information being the same as the fourth form information, transmitting, to the remote server, an indication that increases a success rate of the received selector; and
in response to the third form information being the same as the fourth form information, transmitting, to the remote server, an indication that increases a success rate associated with the other received selector.

13. The electronic device of claim 8, wherein the processor is also configured to:
in response to the autofilling, determine whether the field of the other form includes the second form information;
in response to determining that the field of the other form includes the second form information, transmit, to the remote server, an indication that increases a success rate associated with the selector; and
in response to determining that the field of the other form does not include the second form information, transmit, to the remote server, an indication that decreases the success rate associated with the selector.

14. The electronic device of claim 8, wherein accessing the account information associated with the user comprises extracting the account information from a browser cookie.

15. A non-transitory computer-readable medium comprising:
computer-readable instructions that, when executed by a processor, cause the processor to perform one or more operations comprising:
receiving an indication that a user has accessed a webpage comprising a form;
responsive to determining that the user is registered with a remote server:
accessing an account information associated with the user, the account information including an attribute;
identifying a field of the form of the webpage, the field including a first form information matching the attribute;
generating a new selector that uniquely identifies the field in a document object model (DOM) associated with the form; and
transmitting, to a remote server, an indication of the new selector for subsequently identifying the field of the form; and
responsive to determining that the user is not registered with the remote server:
receiving, from the remote server, a selector selected from a plurality of selectors associated with the webpage, wherein each respective selector of the plurality of selectors is associated with a respective success rate indicating how frequently the respective selector correctly identified the field in the DOM, and the received selector is associated with a highest success rate relative to the plurality of selectors;
accessing a second form information from a field of the form associated with the received selector; and
autofilling a field of another form with the second form information.

16. The non-transitory computer-readable medium of claim 15, wherein the transmitting is performed in response to a submission of the form.

17. The non-transitory computer-readable medium of claim 15, wherein generating the new selector comprises at least one of the following:
generating a path from a root of the DOM to the field in the DOM;
generating a path from the root of the DOM to a nearest ancestor with a single input relative to the field in the DOM;
generating a path to a nearest ID attribute named according to the field;
generating a class list associated with the nearest ancestor relative to the field, the nearest ancestor having a unique class list; or
generating an attribute list associated with the field, the field having a unique attribute list.

18. The non-transitory computer-readable medium of claim 15, wherein the computer-readable instructions cause the processor to perform one or more operations also comprising, before autofilling the field of the other form:
receiving, from the remote server, another selector from the plurality of selectors associated with the webpage; and
accessing a third form information from a field of the form associated with the other received selector.

19. The non-transitory computer-readable medium of claim 18, wherein, autofilling the field of the other form with the second form information comprises:
comparing the second form information with the third form information;
in response to the second form information being the same as the third form information, autofilling the field of the other form with the second form information; and
in response to the second form information not being the same as the third form information:
receiving a fourth form information input into the field of the other form; and
in response to the second form information being the same as the fourth form information, transmitting, to the remote server, an indication that increases a success rate of the received selector; and
in response to the third form information being the same as the fourth form information, transmitting, to the remote server, an indication that increases a success rate associated with the other received selector.

20. The non-transitory computer-readable medium of claim 15, wherein the computer-readable instructions cause the processor to perform one or more operations also comprising:
in response to the autofilling, determining whether the field of the other form includes the second form information;
in response to determining that the field of the other form includes the second form information, transmitting, to the remote server, an indication that increases a success rate associated with the selector; and
in response to determining that the field of the other form does not include the second form information, transmitting, to the remote server, an indication that decreases the success rate associated with the selector.
